(19) United States
(12) Patent Application Publication
(10) Pub. No.: US 2009/0205623 A1
(43) Pub. Date: Aug. 20, 2009

(54) DEVICE FOR ADJUSTING KINETIC ENERGY OF VEHICLES AND SIMILAR

(76) Inventor: Ignazio Congiu, Pomezia (IT)

Correspondence Address: YOUNG & THOMPSON, 209 Madison Street, Suite 500, ALEXANDRIA, VA, 22314, US

(21) Appl. No.: 12/305,113

(22) PCT Filed: Jun. 16, 2006
(86) PCT No.: PCT/IT2006/000458

§ 371 Date: Dec. 16, 2008

(51) Int. Cl. F41B 11/00; F04B 35/00; F16K 49/00

(52) U.S. Cl. 124/55; 417/364; 137/341

(57) ABSTRACT

A device includes elements for controlling longitudinal kinetic energy of vehicles, and further elements for controlling inertia during driving in any direction, including one or more pipes (13) firing in the direction opposite to the running direction or in the direction of the centrifugal force, one shot or a controlled series of shots in a more or less quick succession, of compressed air or special blank charges.

The present invention concerns a device for adjusting kinetic energy of vehicles and similar, working with compressed air and/or blank charges fired into special pipes installed on board.

It is known that at present vehicles, cars, motor-cycles and also commercial vehicles and trains are provided, for slowing down and blocking their movement, with means for dissipating kinetic energy accumulated during said movement, by means of friction of the movable parts on the ground.

In cars, motor-cycles and lorries on the road, the braking device and all parts which contribute in dissipating said kinetic energy undergo wear and tear, which however depends also on the typology of the ground and on the climatic conditions. Furthermore, with the same road-bed, the time and the space for stopping a vehicle are strongly conditioned by many other parameters.

Similar considerations may be considered valid also for aeroplanes and helicopters, flying and landing.

It is the main aim of the present invention to allow dissipating part or all of the kinetic energy of a vehicle, independently of the road-bed and the climatic conditions.

A further aim is the one of adjusting the stability of a vehicle in a rectilinear and uniform motion, as well as in various or accidental motion, during skidding and in a bend.

According to physical principles it is known, for example, that the kinetic energy of a vehicle is thus determined:

E=_mv²

wherein m is the mass in kg of the vehicle and v the speed in meters/second, so that a vehicle with the exemplifying weight of 1000 kg moving at a speed of 100 km/h=27.77 m/sec, has the following kinetic energy:

E=500.(27.77)²=771173 Joule.

According to the present invention, an equivalent energy may be produced with a mass of compressed air or a blank charge of 2 kg fired at a speed of about 440 m/sec, i.e. of 4 kg at 220 m/sec, in the sense opposed to the running direction.

Of course, this would mean the destruction of the vehicle or at least an irreversible deformation of the body, if it is not duly realized.

A functional and safe braking is obtained by means of the device according to the present invention which, in a first variant, is of the one-direction type but swinging in the direction of the centrifugal force, consisting of one or more pipes, similar to the barrels of a gun, which fire a shot or a controlled series of shots of compressed air or with special blank charges, in a more or less quick sequence, in the direction opposite to the running direction or in the direction of the centrifugal force.

The device according to the present invention may be operated through the common brake pedal which, in the present case, works only in determined conditions through an electronic control, e.g. when a determined speed and/or a determined pressure onto the pedal has been exceeded, and/or by means of a special control.

A more elaborate application of the device according to the present invention may allow to control dynamic reactions during the motion of a vehicle, on the earth as well as in the air.

E.g., it will be possible for a rally pilot driving a rally car provided with the device according to the present invention, and who is jumping a hump, to modify his landing point or to anticipate or postpone the same, but also to translate and to vary the trajectory.

Similar applications may be done on aeroplanes, e.g. during a long landing, for avoiding a wrong strip, and in many cases of emergency landing or falling down, so that the possibility of dissipating as much kinetic energy as possible reduces of a great deal all negative consequences.

Another use to be considered of the device according to the present invention is in case of breakdown of the control systems: it is possible, with a series of devices according to the present invention, to control and drive the aircraft.

The installation of the device according to the present invention on warplanes may facilitate or, in any case, make safer the combat or the deck-landing on aircraft carriers or the landing on short strips.

A further possible application may be the emergency use in case a parachute does not open: in fact the used, when he is near to the ground, may dissipate a great deal of the kinetic energy and therefore of the speed before the contact with the ground.

Further applications may be done on watercrafts for allowing the means to stop in very limited space conditions, specially for boats used in high traffic ports.

The present invention will be described more in detail hereinbelow relating to the enclosed figures in which some structural and operative examples thereof are shown.

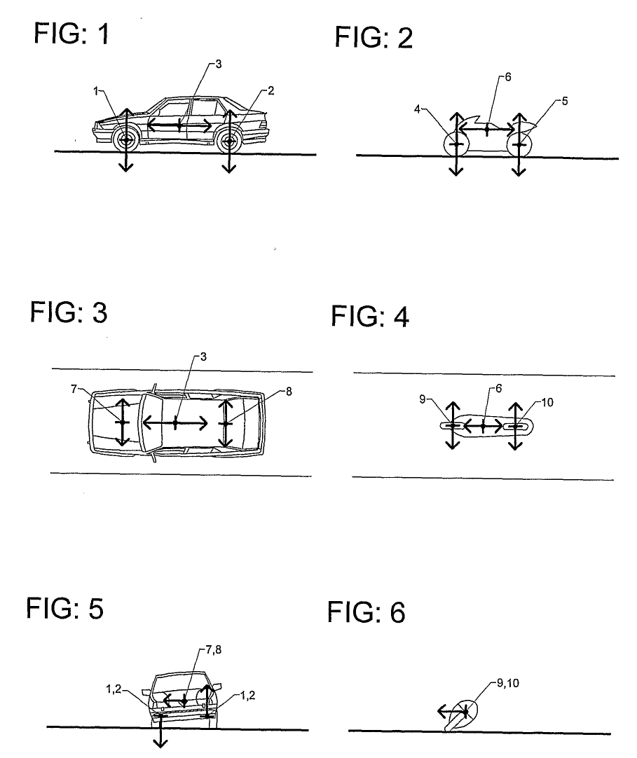

FIG. 1 shows the profile of a four wheel vehicle with the possible housing of the device for adjusting kinetic energy of vehicles and similar according to the present invention shown therein and the action directions of the same.

FIG. 2 shows the profile of a two-wheel vehicle with the possible housings of the device according to the present invention shown, and the action directions of the same.

FIG. 3 shows a plane view of a four-wheel vehicle with the possible housing of the device according to the present invention and the action directions of the same.

FIG. 4 shows a plane view of a two-wheel vehicle with the possible housings of the device according to the present invention and the action directions of the same.

FIG. 5 shows a front view of a for wheel vehicle with the possible housings of the device according to the present invention and the action directions thereof for stabilizing the vehicle following to taking a bend or the beginning of a skidding.

FIG. 6 shows a front view of a two-wheel vehicle with the possible housings of the device according to the present invention and the action directions for stabilizing the vehicle following to taking a bend or the beginning of a skidding.

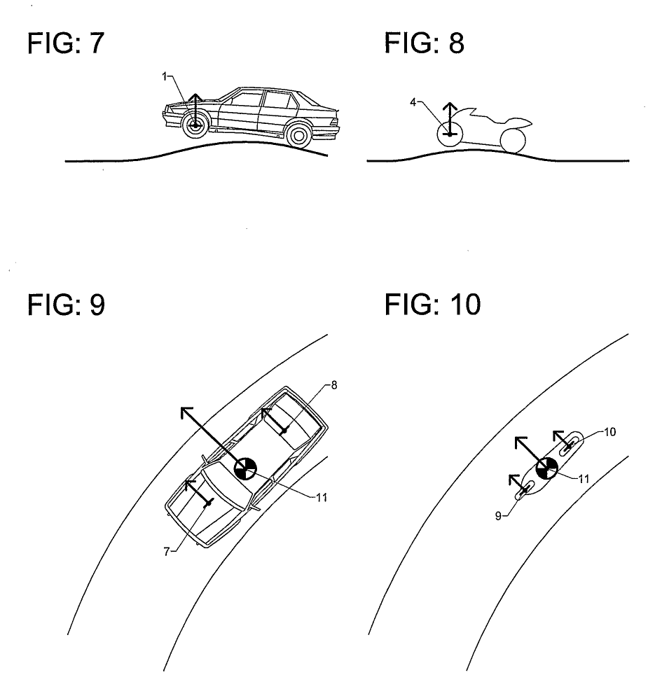

FIG. 7 shows the profile of a for wheel vehicle with the possible housings of the device according to the present invention and the action directions for stabilizing the vehicle following to jumping a cat's back.

FIG. 8 shows the profile of a two-wheel vehicle with the possible housings of the device according to the present invention and the action directions for stabilizing the vehicle following to jumping a cat's back.

FIG. 9 shows a plane view of a four-wheel vehicle with the possible housings of the device according to the present invention and the action directions for stabilizing the vehicle running a bend.

FIG. 10 shows a plane view of a two-wheel vehicle with the possible housings of the device according to the present invention and the action directions for stabilizing the vehicle running a bend.

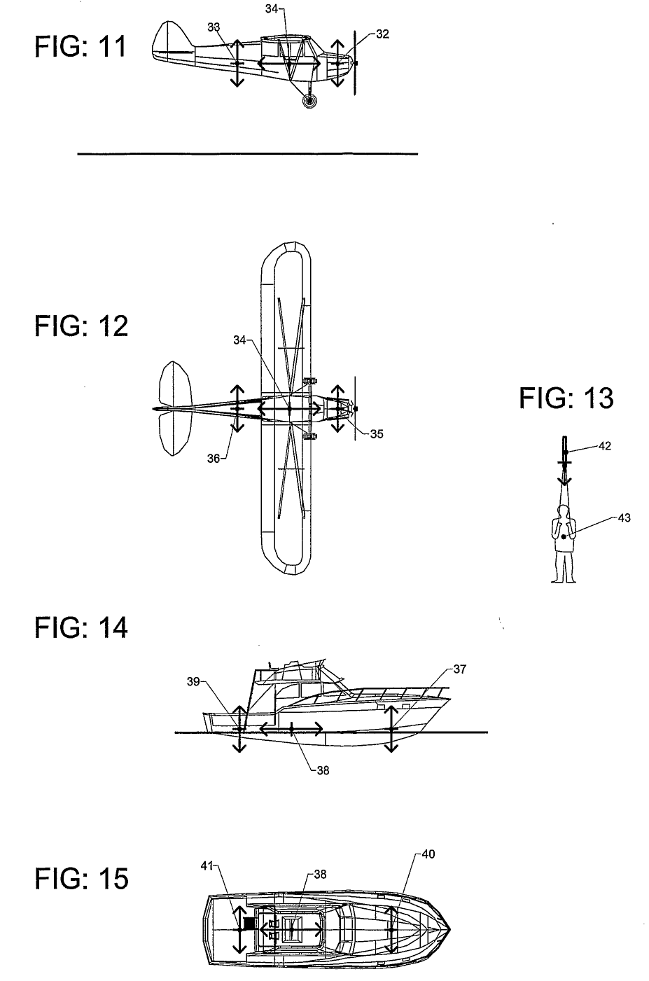

FIG. 11 shows the profile of an aeroplane with the possible housings of the device according to the present invention and the action directions for stabilizing the aircraft during the flight or while landing.

FIG. 12 shows a plane view of an aeroplane with the possible housings of the device according to the present invention and the action directions for stabilizing the aircraft during the flight or while landing.

FIG. 13 shows a parachutist during falling with a possible use of the device according to the present invention and the action direction for the use thereof.

FIG. 14 shows the profile of a watercraft with the possible housings of the device according to the present invention and the action directions for the use thereof.

FIG. 15 shows a plane view of a watercraft with the possible housings of the device according to the present invention and the action directions for the use thereof.

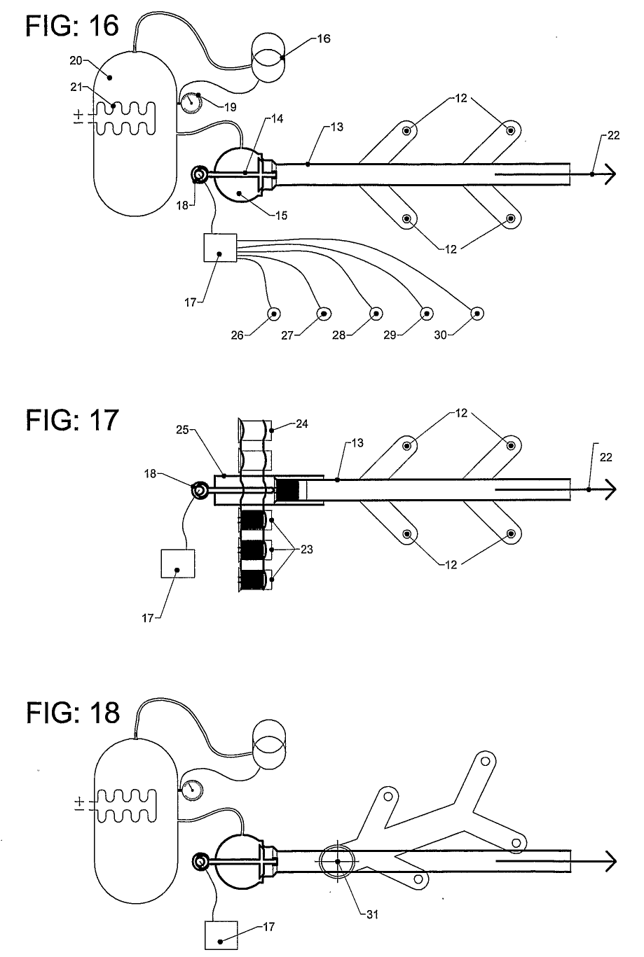

FIG. 16 shows a scheme of the compressed air device according to the present invention.

FIG. 17 shows a scheme of the blank charges device according to the present invention.

FIG. 18 shows a scheme of the compressed air device according to the present invention and according to FIG. 16, but provided with a mechanism making it rotary.

Relating now to the details shown in the enclosed figures, the device for adjusting kinetic energy of vehicles and similar according to the present invention comprises, in above mentioned variants:

a compressed air or blank charges device 1, housed in correspondence with the two front driveshafts, one to the right and one to the left, in vertical direction in a for-wheel vehicle;

a compressed air or blank charge device 2, housed in correspondence with the two back driveshafts, one to the right and one to the left, in vertical direction in a four-wheel vehicle;

a compressed air or blank charge device 3, housed in correspondence with the longitudinal shaft, in longitudinal direction in a four-wheel vehicle;

a compressed air or bank charge device 4, housed in correspondence with the front wheel, in vertical direction in a two-wheel vehicle;

a compressed air or blank charge device 5, housed in correspondence with the back wheel, in longitudinal direction in a two-wheel vehicle;

a compressed air or blank charge device 6, housed in correspondence with the longitudinal shaft, in longitudinal direction in a two-wheel vehicle;

a compressed air or blank charge device 7, housed in correspondence with the front shaft, one to the right and one to the left, in a four-wheel vehicle;

a compressed air or blank charge device 8, housed in correspondence with the back shaft, one to the right and one to the left, in a four-wheel vehicle;

a compressed air or blank charge device 9, housed in correspondence with the front wheel, one to the right and one to the left, in a two-wheel vehicle;

a compressed air or blank charge device 10, housed in correspondence with the back wheel, one to the right and one to the left, in a two-wheel vehicle;

a barycentre 11 with the action direction of the centrifugal force of a vehicle running a bend;

a support 12 for fixing the device according to the present invention to the body of the vehicle;

a pipe 13 for the expansion of the compressed air or of the blank charge;

a valve 14 operated by a motor 18, by which the compressed air enters the pipe;

a chamber 15 for the compressed air;

a compressor 16 controlled by a manometer 19 and operated by the vehicle's motor or by an auxiliary motor;

an electronic central 17 that controls the speed of the firings according to the impulses received by the different sensors;

an electric step-by-step motor 18 controlled by said electronic central 17;

a manometer 19 that controls the functioning of the compressor 16;

a tank 20 for the compressed air;

an electric resistance 21 for heating up the compressed air while, in a variant, the cooling fluid of the motor or the lubricant circulation may be used;

an expansion direction 22 of the compressed air along pipe 13;

a series of loaded blank charges 23;

a series of unloaded blank charges 24;

a half-automatic mechanism 25 for loading the blank charges 23;

a sensor 26 in the brake pedal;

a sensor 27 in the speedometer;

a sensor 28 in the ABS device of the braking system;

a series of gravitational sensors 29 in the body of the vehicle, recording the different accelerations and activating the devices installed for adjusting the trim;

a sensor 30 connected to a gyroscope;

an articulation 31 that allows the controlled orientation through gravitational sensors or by the simple action of gravitational force;

a compressed air or blank charge device 32, housed in correspondence with the front part, in vertical direction, in an aeroplane;

a compressed air or blank charge device 33, housed in correspondence with the tail, in vertical direction, in an aeroplane;

a compressed air or blank charge device 34, housed in correspondence with the longitudinal axis, in longitudinal direction, in an aeroplane;

a compressed air or blank charge device 35, housed in correspondence with the front part, one to the right and one to the left, in an aeroplane;

a compressed air or blank charge device 36, housed in correspondence of the tail, one to the right and one to the left, in an aeroplane;

a compressed air or blank charge device 37, housed in correspondence with the front part, in vertical direction, in a watercraft;

a compressed air or blank charge device 38, housed in correspondence with the longitudinal shaft, in longitudinal direction in a watercraft;

a compressed air or blank charge device 39, housed in correspondence with the tail, in vertical direction in a watercraft;

a compressed air or blank charge device 40, housed in correspondence with the front part, one to the right and one to the left, in a watercraft;

a compressed air or blank charge device 41, housed in correspondence with the tail, one to the right and one to the left, in a watercraft;

a compressed air or blank charge device 42, slung to a parachutist 43, with downward action direction.

1. A device for adjusting kinetic energy of vehicles, characterized in the emission of compressed air and/or blank charges fired in special pipes installed on said vehicles, aeroplanes, watercrafts and similar and on human users, like parachutists, for slowing down and/or stopping the motion.

2. A device according to claim 1, characterized in the presence of one or more one-directional means acting as an auxiliary or primary braking system or for performing small movings on four-wheel vehicles, characterized in:
a compressed air or blank charges means (1), housed in correspondence with the two front driveshafts, one to the right and one to the left, in vertical direction;
a compressed air or blank charge means (2), housed in correspondence with the two back driveshafts, one to the right and one to the left, in vertical direction;
a compressed air or blank charge means (3), housed in correspondence with the longitudinal shaft, in longitudinal direction;
a compressed air or blank charge means (7), housed in correspondence with the front shaft, one to the right and one to the left;
a compressed air or blank charge means (8), housed in correspondence with the back shaft, one to the right and one to the left;
a pipe (13) for the expansion of the compressed air or of the blank charge.

3. A device according to claim 1, characterized in the presence, in two-wheel vehicles, of:
a compressed air or bank charge means (4), housed in correspondence with the front wheel, in vertical direction;
a compressed air or blank charge means (5), housed in correspondence with the back wheel, in longitudinal direction;
a compressed air or blank charge means (6), housed in correspondence with the longitudinal shaft, in longitudinal direction;
a compressed air or blank charge means (9), housed in correspondence with the front wheel, one to the right and one to the left;
a compressed air or blank charge means (10), housed in correspondence with the back wheel, one to the right and one to the left;
a pipe (13) for the expansion of the compressed air or of the blank charge.

4. A device according to claim 1, characterized in:
a valve (14) operated by a motor (18), by which the compressed air enters the pipe;
a chamber (15) for the compressed air;
a compressor (16) controlled by a manometer (19) and operated by the vehicle's motor or by an auxiliary motor;
an electronic central (17) that controls the speed of the firings according to the impulses received by the different sensors;
an electric step-by-step motor (18) controlled by said electronic central (17);
a manometer (19) that controls the functioning of the compressor (16);
a tank (20) for the compressed air;
an electric resistance (21) for heating up the compressed air and/or the heat of the cooling fluid of the motor or the lubricant circulation;
a series of loaded blank charges (23);
a series of unloaded blank charges (24);
a half-automatic mechanism (25) for loading the blank charges (23);
a sensor (26) in the brake pedal;
a sensor (27) in the speedometer;
a sensor (28) in the ABS device of the braking system;
a series of gravitational sensors (29) in the body of the vehicle, recording the different accelerations and activating the devices installed for adjusting the trim;
a sensor (30) connected to a gyroscope;
an articulation (31) that allows the controlled orientation through gravitational sensors or by the simple action of gravitational force.

5. A device according to claim 1, of the kind to be applied to aircrafts and similar, characterized in:
a compressed air or blank charge means (33), housed in correspondence with the tail, in vertical direction;
a compressed air or blank charge means (34), housed in correspondence with the longitudinal axis, in longitudinal direction;
a compressed air or blank charge means (35), housed in correspondence with the front part, one to the right and one to the left;
a compressed air or blank charge means (36), housed in correspondence of the tail, one to the right and one to the left;

6. A device according to claim 1, of the kind to be applied to watercrafts and similar, characterized in:
a compressed air or blank charge means (37), housed in correspondence with the front part, in vertical direction;
a compressed air or blank charge means (38), housed in correspondence with the longitudinal shaft, in longitudinal direction;
a compressed air or blank charge means (39), housed in correspondence with the tail, in vertical direction;
a compressed air or blank charge means (40), housed in correspondence with the front part, one to the right and one to the left;
a compressed air or blank charge means (41), housed in correspondence with the tail, one to the right and one to the left.

7. A device according to claim 1, characterized in the presence of a compressed air or blank charges means (42), slung to a parachutist (43), with downward action.
